(19) United States
(12) Patent Application Publication
(10) Pub. No.: US 2025/0061686 A1
(43) Pub. Date: Feb. 20, 2025

(54) AN IMAGE PROCESSING METHOD AND APPARATUS

(71) Applicant: Beijing Zitiao Network Technology Co., Ltd., Beijing (CN)

(72) Inventor: Hang DONG, Beijing (CN)

(21) Appl. No.: 18/725,661

(22) PCT Filed: Dec. 27, 2022
(86) PCT No.: PCT/CN2022/142286

§ 371 Date: Jun. 28, 2024

(30) Foreign Application Priority Data
Dec. 28, 2021 (CN) 202111628721.3

(51) Int. Cl. G06V 10/52; G06V 10/77; G06V 10/80; G06V 10/82

(52) U.S. Cl. CPC G06V 10/52; G06V 10/7715; G06V 10/806; G06V 10/82

(57) ABSTRACT

Embodiments of the present disclosure relate to the technical field of image processing, and provide an image processing method and apparatus. The method includes: respectively performing feature extraction on an image to be processed from a plurality of different spatial scales to obtain a target feature and at least one feature to be fused; fusing the target feature and the at least one feature to be fused to obtain a first feature; extracting a high-frequency feature and a low-frequency feature from the target feature; processing the high-frequency feature on the basis of a residual dense block (RDB) to obtain a second feature; fusing the low-frequency feature and the at least one feature to be fused to obtain a third feature; combining the first feature, the second feature and the third feature to obtain a fused feature; and processing the image to be processed on the basis of the fused feature.

### CROSS-REFERENCE TO RELATED APPLICATIONS

This application is a U.S. National Stage under 35 U.S.C. § 371 of International Application No. PCT/CN2022/142286 filed on Dec. 27, 2022, which is based on and claims the priority of the application with Chinese application number 202111628721.3, filed on Dec. 28, 2021, the disclosure content of each of these applications are hereby incorporated into this application in their entireties.

### TECHNICAL FIELD

The present disclosure relates to the field of image processing technology, and in particular, to an image processing method and apparatus.

### BACKGROUND

Image repair refers to repair and reconstruction of damaged images or removal of redundant objects in images.

### SUMMARY

In view of this, the present disclosure provides an image processing method and apparatus. The technical solution is as follows.

In a first aspect, an embodiment of the present disclosure provides an image processing method, comprising:
performing feature extraction on an image to be processed from a plurality of different spatial scales respectively, to obtain a target feature and at least one feature to be fused;
fusing the target feature and the at least one feature to be fused to obtain a first feature;
extracting high-frequency features and low-frequency features from the target feature;
processing the high-frequency features based on a residual dense block (RDB) to obtain a second feature;
fusing the low-frequency features and the at least one feature to be fused to obtain a third feature;
combining the first feature, the second feature and the third feature to obtain a fused feature; and
processing the image to be processed based on the fused feature.

As an implementation of the embodiment of the present disclosure, the extracting high-frequency features and low-frequency features from the target feature includes:
performing discrete wavelet decomposition on the target feature to obtain a fourth feature;
determining features of first preset number of channels of the fourth feature as the low-frequency features, and features of other channels in the fourth feature except the low-frequency features as the high-frequency features.

As an implementation of the embodiment of the present disclosure, after extracting high-frequency features and low-frequency features in the target feature, the method further includes:
processing the high-frequency features and the low-frequency features respectively through a convolution layer to reduce the number of channels of the high-frequency features and the low-frequency features to a preset value.

As an implementation of the embodiment of the present disclosure, the fusing the low-frequency features and the at least one feature to be fused to obtain a third feature includes:
sorting the at least one feature to be fused in descending order according to the spatial scale difference between the at least one feature to be fused and the low-frequency features, to obtain a first sorting result;
fusing the first feature to be fused and the low-frequency feature to obtain the fused feature corresponding to the first feature to be fused, the first feature to be fused being the first feature to be fused in the first sorting result;
fusing other features to be fused in the first sorting result and the fused feature corresponding to the previous feature to be fused one by one, to obtain fused features corresponding to other features to be fused in the first sorting result; and determining the corresponding fused feature of the last feature to be fused in the first sorting result as the third feature.

As an implementation of the embodiment of the present disclosure, the fusing the first feature to be fused and the low-frequency feature to obtain the fused feature corresponding to the first feature to be fused includes:
sampling the low-frequency feature as a first sampled feature;
the first sampled feature having the same spatial scale as the first feature to be fused;
calculating the difference between the first sampled feature and the first feature to be fused, to obtain a first difference feature;
sampling the first difference feature as a second sampled feature; the second sampled feature having the same spatial scale as the low-frequency feature; and
additively fusing the low-frequency feature and the second sampled feature to generate a fused feature corresponding to the first feature to be fused.

As an implementation of the embodiment of the present disclosure, the fusing other features to be fused in the first sorting result and the fused feature corresponding to the previous feature to be fused one by one, to obtain fused features corresponding to other features to be fused in the first sorting result includes:
sampling the fused feature corresponding to the m−1-th feature to be fused in the first sorting result as a third sampled feature; the third sampled feature having the same spatial scale as the m-th feature to be fused in the first sorting result, m being an integer greater than 1;
calculating the difference between the m-th feature to be fused and the third sampled feature to obtain a second difference feature;
sampling the second difference feature as a fourth sampled feature; the fourth sampled feature having the same spatial scale as the fused feature corresponding to the m−1-th feature to be fused; and
additively fusing the fused feature corresponding to the m−1-th feature to be fused and the fourth sampled feature to generate a fused feature corresponding to the m-th feature to be fused.

As an implementation of the embodiment of the present disclosure, the fusing the target feature and the at least one feature to be fused to obtain a first feature includes:
dividing the target feature into a fifth feature and a sixth feature;
processing the fifth feature based on a residual dense block (RDB) to obtain a seventh feature;
fusing the sixth feature and the at least one feature to be fused to obtain an eighth feature;
combining the seventh feature and the eighth feature to generate the first feature.

As an implementation of the embodiment of the present disclosure, fusing the sixth feature and the at least one feature to be fused to obtain an eighth feature includes:
sorting the at least one feature to be fused in descending order according to the spatial scale difference between the at least one feature to be fused and the sixth feature, to obtain a second sorting result;
fusing a second feature to be fused and the sixth feature to obtain the fused feature corresponding to the second feature to be fused, the second feature to be fused being the first feature to be fused in the second sorting result;
fusing other features to be fused in the second sorting result and the fused feature corresponding to the previous feature to be fused one by one, to obtain fused features corresponding to the other features to be fused in the second sorting result; and
determining the fused feature corresponding to the last feature to be fused in the second sorting result as the eighth feature.

As an implementation of the embodiment of the present disclosure, the fusing a second feature to be fused and the sixth feature to obtain the fused feature corresponding to the second feature to be fused includes:
sampling the sixth feature as a fifth sampled feature, the fifth sampled feature having the same spatial scale as the second feature to be fused;
calculating the difference between the fifth sampled feature and the first feature to be fused in the second sorting result, to obtain the third difference feature;
sampling the third difference feature as a sixth sampled feature, the sixth sampled feature having the same spatial scale as the sixth feature; and
additively fusing the sixth feature and the sixth sampled feature to generate a fused feature corresponding to the second feature to be fused.

As an implementation of the embodiment of the present disclosure, the fusing other features to be fused in the second sorting result and the fused feature corresponding to the previous feature to be fused one by one, to obtain fused features corresponding to other features to be fused in the second sorting result includes:
sampling the fused feature corresponding to the n−1-th feature to be fused in the second sorting result as a seventh sampled feature; the seventh sampled feature having the same spatial scale as the n-th feature to be fused in the second sorting result, n being an integer greater than 1;
calculating the difference between the n-th feature to be fused and the seventh sampled feature to obtain a fourth difference feature;
sampling the fourth difference feature as an eighth sampled feature, the eighth sampled feature having the same spatial scale as the fused feature corresponding to the n−1-th feature to be fused; and
additively fusing the fused feature corresponding to the n−1-th feature to be fused and the eighth sampled feature to generate a fused feature corresponding to the n-th feature to be fused.

As an implementation of the embodiment of the present disclosure, the dividing the target feature into a fifth feature and a sixth feature includes:
dividing the target feature into a fifth feature and a sixth feature based on feature channels of the target feature.

In a second aspect, an embodiment of the present disclosure provides an image processing method, comprising: processing an image to be processed through an encoding module to obtain an encoded feature; wherein the encoding module includes L cascaded encoders with different spatial scales, and the i-th encoder is used to perform feature extraction on the image to be processed to obtain an image feature on the i-th encoder, and obtain fused features output by all encoders before the i-th encoder, and obtain the fused feature of the i-th encoder through the image processing method described in any one of claims 1-11, and output the fused features of the i-th encoder to all encoders after the i-th encoder, L and i both being positive integers, and i≤L;
processing the encoded feature through a feature restoration module composed of at least one residual block (RDB) to obtain a restored feature;
processing the restored feature through a decoding module to obtain a processing result image of the image to be processed;
wherein the decoding module includes L cascaded decoders with different spatial scales, and the j-th decoder is used to fuse an image feature of the encoding module on the j-th encoder and the fusion results output by all decoders before the j-th decoder, generate a fusion result of the j-th decoder, and output the fusion result of the j-th decoder to all decoders after the j-th decoder.

As an implementation of the embodiment of the present disclosure, the processing the restored feature through a decoding module to obtain a processing result image of the image to be processed includes:
dividing the image feature on the j-th decoder into a ninth feature and a tenth feature;
processing the ninth feature based on a residual dense block (RDB) to obtain an eleventh feature;
fusing the tenth feature and fusion results output by all decoders before the j-th decoder to obtain a twelfth feature;
combining the eleventh feature and the twelfth feature to generate a fusion result of the j-th decoder.

In a third aspect, an embodiment of the present disclosure provides an image processing apparatus, comprising: a feature extraction unit configured to perform feature extraction on an image to be processed from a plurality of different spatial scales respectively, to obtain a target feature and at least one feature to be fused;
a first processing unit configured to fuse the target feature and the at least one feature to be fused to obtain a first feature;
a second processing unit configured to extract high-frequency features and low-frequency features from the target feature, process the high-frequency features based on a residual dense block (RDB) to obtain a second features, and fuse the low-frequency features and the at least one feature to be fused to obtain a third feature;
a fusion unit configured to combine the first feature, the second feature and the third feature to obtain a fused feature;
a third processing unit configured to process the image to be processed based on the fused feature.

As an implementation of the embodiment of the present disclosure, the second processing unit is specifically configured to perform discrete wavelet decomposition on the target feature to obtain a fourth feature;
determine features of first preset number of channels of the fourth feature as the low-frequency features, and features of other channels in the fourth feature except the low-frequency features as the high-frequency features.

As an implementation of the embodiment of the present disclosure, the second processing unit is further configured to process the high-frequency features and the low-frequency features respectively through a convolution layer to reduce the number of channels of the high-frequency features and the low-frequency features to a preset value.

As an implementation of the embodiment of the present disclosure, the second processing unit is specifically configured to sort the at least one feature to be fused in descending order according to the spatial scale difference between the at least one feature to be fused and the low-frequency features, to obtain a first sorting result; fuse the first feature to be fused and the low-frequency feature to obtain the fused feature corresponding to the first feature to be fused, the first feature to be fused being the first feature to be fused in the first sorting result; fuse other features to be fused in the first sorting result and the fused feature corresponding to the previous feature to be fused one by one, to obtain fused features corresponding to other features to be fused in the first sorting result; and determine the corresponding fused feature of the last feature to be fused in the first sorting result as the third feature.

As an implementation of the embodiment of the present disclosure, the second processing unit is specifically configured to sample the low-frequency feature as a first sampled feature; the first sampled feature having the same spatial scale as the first feature to be fused; calculate the difference between the first sampled feature and the first feature to be fused, to obtain a first difference feature; sample the first difference feature as a second sampled feature; the second sampled feature having the same spatial scale as the low-frequency feature; and additively fusing the low-frequency feature and the second sampled feature to generate a fused feature corresponding to the first feature to be fused.

As an implementation of the embodiment of the present disclosure, the second processing unit is specifically configured to sample the fused feature corresponding to the m−1-th feature to be fused in the first sorting result as a third sampled feature; the third sampled feature having the same spatial scale as the m-th feature to be fused in the first sorting result, m being an integer greater than 1; calculate the difference between the m-th feature to be fused and the third sampled feature to obtain a second difference feature; sample the second difference feature as a fourth sampled feature; the fourth sampled feature having the same spatial scale as the fused feature corresponding to the m−1-th feature to be fused;
and additively fuse the fused feature corresponding to the m−1-th feature to be fused and the fourth sampled feature to generate a fused feature corresponding to the m-th feature to be fused.

As an implementation of the embodiment of the present disclosure, the first processing unit is specifically configured to divide the target feature into a fifth feature and a sixth feature; process the fifth feature based on a residual dense block (RDB) to obtain a seventh feature; fuse the sixth feature and the at least one feature to be fused to obtain an eighth feature; combine the seventh feature and the eighth feature to generate the first feature.

As an implementation of the embodiment of the present disclosure, the first processing unit is specifically configured to sort the at least one feature to be fused in descending order according to the spatial scale difference between the at least one feature to be fused and the sixth feature, to obtain a second sorting result; fuse a second feature to be fused and the sixth feature to obtain the fused feature corresponding to the second feature to be fused, the second feature to be fused being the first feature to be fused in the second sorting result; fuse other features to be fused in the second sorting result and the fused feature corresponding to the previous feature to be fused one by one, to obtain fused features corresponding to the other features to be fused in the second sorting result; and determine the fused feature corresponding to the last feature to be fused in the second sorting result as the eighth feature.

As an implementation of the embodiment of the present disclosure, the first processing unit is specifically configured to sample the sixth feature as a fifth sampled feature, the fifth sampled feature having the same spatial scale as the second feature to be fused; calculate the difference between the fifth sampled feature and the first feature to be fused in the second sorting result, to obtain the third difference feature; sample the third difference feature as a sixth sampled feature, the sixth sampled feature having the same spatial scale as the sixth feature; and additively fuse the sixth feature and the sixth sampled feature to generate a fused feature corresponding to the second feature to be fused.

As an implementation of the embodiment of the present disclosure, the first processing unit is specifically configured to sample the fused feature corresponding to the n−1-th feature to be fused in the second sorting result as a seventh sampled feature; the seventh sampled feature having the same spatial scale as the n-th feature to be fused in the second sorting result, n being an integer greater than 1; calculate the difference between the n-th feature to be fused and the seventh sampled feature to obtain a fourth difference feature; sample the fourth difference feature as an eighth sampled feature, the eighth sampled feature having the same spatial scale as the fused feature corresponding to the n−1-th feature to be fused; and additively fuse the fused feature corresponding to the n−1-th feature to be fused and the eighth sampled feature to generate a fused feature corresponding to the n-th feature to be fused.

As an implementation of the embodiment of the present disclosure, the first processing unit is specifically configured to divide the target feature into a fifth feature and a sixth feature based on feature channels of the target feature.

In a fourth aspect, an embodiment of the present disclosure provides an image processing apparatus, comprising: a feature extraction unit configured to process an image to be processed through an encoding module to obtain an encoded feature; wherein the encoding module includes L cascaded encoders with different spatial scales, and the i-th encoder is used to perform feature extraction on the image to be processed to obtain an image feature on the i-th encoder, and obtain fused features output by all encoders before the i-th encoder, and obtain the fused feature of the i-th encoder through the image processing method described in any one of claims 1-11, and output the fused features of the i-th encoder to all encoders after the i-th encoder, L and i both being positive integers, and i≤L;
a feature processing unit configured to process the encoded feature through a feature restoration module composed of at least one residual block (RDB) to obtain a restored feature; an image generation unit configured to process the restored feature through a decoding module to obtain a processing result image of the image to be processed; wherein the decoding module includes L cascaded decoders with different spatial scales, and the j-th decoder is used to fuse an image feature of the encoding module on the j-th encoder and the fusion results output by all decoders before the j-th decoder, generate a fusion result of the j-th decoder, and output the fusion result of the j-th decoder to all decoders after the j-th decoder.

As an implementation of the embodiment of the present disclosure, the image generation unit is specifically configured to divide the image feature on the j-th decoder into a ninth feature and a tenth feature; process the ninth feature based on a residual dense block (RDB) to obtain an eleventh feature; fuse the tenth feature and fusion results output by all decoders before the j-th decoder to obtain a twelfth feature; combine the eleventh feature and the twelfth feature to generate a fusion result of the j-th decoder.

In a fifth aspect, an embodiment of the present disclosure provides an electronic device, comprising: a memory and a processor, wherein the memory is configured to store a computer program; the processor is configured to, when calling the computer program, cause the electronic device to implement any of above image processing methods.

In a sixth aspect, an embodiment of the present disclosure provides a computer-readable storage medium, which, when the computer program is executed by a computing device, causes the computing device to implement any of the above image processing methods.

In a seventh aspect, an embodiment of the present disclosure provides a computer program product, which, when runs on a computer, causes the computer to implement any of the above image processing methods.

The image processing methods provided by the embodiments of the present disclosure, after performing feature extraction on an image to be processed from a plurality of different spatial scales to obtain a target feature and at least one feature to be fused, on one hand, fuse the target feature and the at least one feature to be fused to obtain a first feature; on the other hand, extract high-frequency features and low-frequency features from the target feature, and perform the high-frequency features based on a residual dense block (RDB) to obtain a second feature, and fuse the low-frequency features and the at least one feature to be fused to obtain a third feature; finally, combine the first feature, the second feature and the third feature to obtain a fused feature, and process the image to be processed based on the fused feature. Since processing features based on RDBs can perform feature updating and redundant feature generation, and fusing low-frequency features and features to be fused can enable introduction of effective information from features at other spatial scales and achieve multi-scale feature fusion, the image processing methods provided by the embodiments of the present disclosure can ensure the generation of new high-frequency features when realizing multi-scale feature fusion of low-frequency features, and fusing of the target feature and the at least one feature to be fused can further enable introduction of effective information from features at other spatial scales, therefore, the image processing methods provided by the embodiments of the present disclosure can improve the effect of image processing.

### BRIEF DESCRIPTION OF THE DRAWINGS

The accompanying drawings, which are incorporated in and constitute a part of this specification, illustrate embodiments consistent with the disclosure and serve to explain the principles of the disclosure together with the description.

In order to more clearly illustrate technical solutions in the embodiments of the present disclosure, the accompanying drawings that need to be used in the description of the embodiments will be introduced briefly follow. Apparently, for those of ordinary skilled in the art, other drawings can also be obtained from these drawings without any creative effort.

FIG. 1 is one of flow charts of steps of an image processing method provided by an embodiment of the present disclosure;

FIG. 2 is one of structural schematic diagrams of a feature fusion network provided by an embodiment of the present disclosure;

FIG. 3 is one of data flow schematic diagrams of an image processing method provided by an embodiment of the present disclosure;

FIG. 4 is another data flow schematic diagram of an image processing method provided by an embodiment of the present disclosure;

FIG. 5 is another flow chart of steps of an image processing method provided by an embodiment of the present disclosure;

FIG. 6 is another structural schematic diagram of a feature fusion network provided by an embodiment of the present disclosure;

FIG. 7 is a flow chart of steps of an image processing method provided by an embodiment of the present disclosure;

FIG. 8 is a schematic structural diagram of an image processing network provided by an embodiment of the present disclosure;

FIG. 9 is a schematic structural diagram of an image processing apparatus provided by an embodiment of the present disclosure;

FIG. 10 is a schematic structural diagram of an image processing apparatus provided by an embodiment of the present disclosure;

FIG. 11 is a schematic diagram of the hardware structure of an electronic device provided by an embodiment of the present disclosure.

### DETAILED DESCRIPTION

In order to understand the above objects, features and advantages of the present disclosure more clearly, the solution of the present disclosure will be further described below. It should be noted that the embodiments of the present disclosure and the features in the embodiments can be combined with each other as long as there is no conflict.

Many specific details are set forth in the following description to fully understand the present disclosure, but the present disclosure can also be implemented in other ways different from those described herein; obviously, the embodiments in the specification are only a part, not all, of embodiments of the present disclosure.

In the embodiments of the present disclosure, words such as “exemplary” or “for example” are used to represent serving as an example, exemplification or illustration. Any embodiment or design solutions described as “exemplary” or “for example” in the embodiments of the disclosure should not be construed as preferred or advantageous over other embodiments or design solutions. More exactly, the use of words such as “exemplary” or “for example” is intended to present related concepts in a specific manner. In addition, in the description of the embodiments of the present disclosure, the meaning of “a plurality of” refers to two or more, unless otherwise specified.

Image repair refers to repair and reconstruction of damaged images or removal of redundant objects in images.

Traditional image processing methods include: image processing methods based on partial differential equations, restoration methods based on global variational squares, restoration methods based on texture synthesis, etc. However, these image processing methods are generally inefficient, and the prior information in images is easy to be invalidated. In order to solve the problems that the prior information in images is easy to be invalidated and the computing efficiency is low in traditional image processing methods, methods based on deep learning have been widely used in various computer vision tasks, which includes image restoration problems. However, since high-frequency information in images is not effectively utilized, the performance of current deep learning-based image restoration network models in detail generation still needs to be improved.

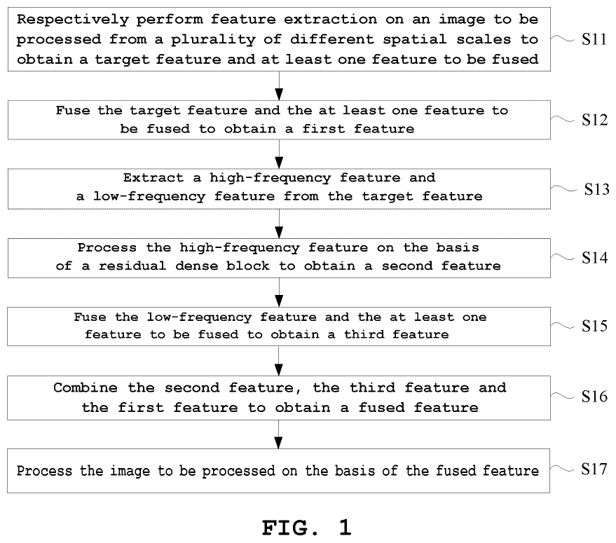

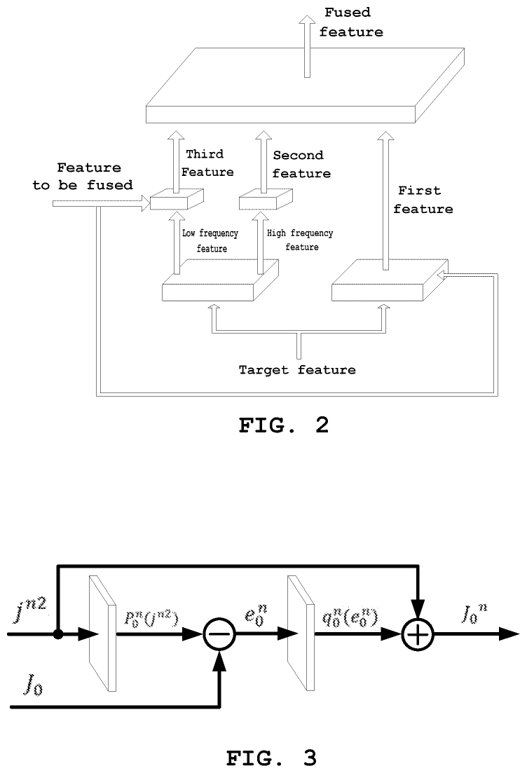

In order to achieve the above object, an embodiment of the present disclosure provides an image processing method. With reference to a flow chart of steps of an image processing method shown in FIG. 1 and a structure diagram of a feature fusion network shown in FIG. 2, the image processing method includes:

S11. Performing feature extraction on an image to be processed from a plurality of different spatial scales respectively, to obtain a target feature and at least one feature to be fused.

Specifically, the target feature in the embodiment of the present disclosure refers to a feature that need to be fused and enhanced, and the feature to be fused refers to a feature used to fuse and enhance a target feature. Specifically, feature extraction can be performed on the image to be processed based on a feature extraction function or a feature extraction network at different spatial scales to obtain the target feature and the at least one feature to be fused.

S12. Fusing the target feature and the at least one feature to be fused to obtain a first feature.

The implementation of fusing the target feature and the at least one feature to be fused is not limited in the embodiment of the present disclosure. The target feature and the at least one feature to be fused can be fused by any feature fusion method.

S13. Extracting high-frequency features and low-frequency features from the target feature.

In some embodiments, the implementation of the above step S13 (extracting high-frequency features and low-frequency features from the target feature) may include:
performing discrete wavelet decomposition on the target feature to obtain a fourth feature;
determining features of first preset number of channels of the fourth feature as the low-frequency features, and features of other channels in the fourth feature except the low-frequency features as the high-frequency features.

That is, first, perform discrete wavelet decomposition on the target feature (C*H*W) to convert the target feature into low-resolution features (4C*1/2H*1/2 W), and then determine features of the 1-st to K-th channels as the low-frequency features, and features of the K+1-th to 4C-th channels as the high-frequency features.

In the embodiment of the present disclosure, the channel of a feature refers to a feature map contained in the feature. One channel of a feature is a feature map obtained by performing feature extraction on features based on a certain dimension. Therefore, the channel of a feature is a feature map in a specific sense.

For example: the size of a target feature is 16*H*W, and the size of a fourth feature is 64*H/2*W/2, then features of the 1-st-16-th channel can be determined as the low-frequency features, and features of the 17-th-48-th channel can be determined as the high frequency features.

As an implementation of the embodiment of the present disclosure, the image processing method provided by the embodiment of the present disclosure further includes:
processing the high-frequency features and the low-frequency features respectively through a convolution layer to reduce the number of channels of the high-frequency features and the low-frequency features to a preset value.

Exemplarily, the preset value may be 8. That is, the number of channels of the high-frequency features and the low-frequency features is compressed to 8 respectively through two convolutional layers.

In some embodiments, the convolution kernel (kerne_size) of the convolution layers used to process the high-frequency features and the low-frequency features is 3*3 and the stride is 2.

Reducing the number of channels of the high-frequency features and the low-frequency features to a preset value can reduce the amount of data processing in the feature fusion process, thereby improving the efficiency of feature fusion.

S14. Processing the high-frequency features based on a Residual Dense Block (RDB) to obtain a second feature.

Specifically, the residual dense block in the embodiment of the present disclosure includes three main parts, which are: Contiguous Memory (CM), Local Feature Fusion (LFF) and Local Residual Learning (LRL). Wherein, CM is mainly used to send the output of the previous RDB to each convolutional layer of the current RDB; LFF is mainly used to fuse the output of the previous RDB with the output of all convolutional layers of the current RDB; and LRL is mainly used to additively fuse the output of the previous RDB with the output of the LFF of the current RDB, and use the additively fused result as the output of the current RDB.

Since RDB can perform feature updating and redundant feature generation, processing high-frequency features based on a residual dense block can increase the diversity of the high-frequency features, thereby making the details in the effect image richer.

S15. Fusing the low-frequency features and the at least one feature to be fused to obtain a third feature.

As an implementation of the embodiment of the present disclosure, the above step S15 (fusing the low-frequency features and the at least one feature to be fused to obtain a third feature) includes the following steps a to step d:

Step a: Sort the at least one feature to be fused in descending order according to the spatial scale difference between the at least one feature to be fused and the low-frequency features, to obtain a first sorting result.

Wherein, the difference in spatial scale between the feature to be fused and the low-frequency feature refers to the difference between the spatial scale of the feature to be fused and the spatial scale of the low-frequency feature.

That is, the greater the difference between the spatial scale of a certain feature to be fused among the at least one feature to be fused and the spatial scale of the low-frequency feature, the closer to the front the position of the feature to be fused in the first sorting result, and the smaller the difference between the spatial scale of a certain feature to be fused and the spatial scale of the low-frequency feature, the further back the position of the feature to be fused in the first sorting result.

Step b: Fusing the first feature to be fused and the low-frequency feature to obtain the fused feature corresponding to the first feature to be fused.

Wherein, the first feature to be fused is the first feature to be fused in the first sorting result.

Referring to FIG. 3, in FIG. 3, taking the first feature to be fused (a first feature to be fused) in the first sorting result being J₀, and the low-frequency feature being jⁿ² as an example to illustrate the above step b. The implementation of the above step b may include the following steps 1 to 4:

Step 1: Sampling the low-frequency feature jⁿ² as a first sampled feature P₀ⁿ (jⁿ²).

Wherein, the first sampled feature P₀ⁿ(jⁿ²) has the same spatial scale as the first feature to be fused J₀.

It should be noted that the sampling in the above steps can be upsampling or downsampling, depending on the spatial scales of the first spatial scale to be fused J₀ in the first sorting result and the low-frequency feature jⁿ².

Step 2: Calculating the difference between the first sampled feature P₀ⁿ(jⁿ²) and the first feature to be fused J₀ in the first sorting result to obtain a first difference feature e₀ⁿ.

The process of the above step 2 may be described as:

$${e}_{0}^{n} = {P}_{0}^{n} ( {j}^{n 2} ) - {J}_{0}$$

Step 3: Sampling the first difference feature e₀ⁿ as a second sampled feature q₀ⁿ(e₀ⁿ).

Wherein, the second sampled feature q₀ⁿ(e₀ⁿ) has the same spatial scale as the low-frequency feature jⁿ².

Similarly, the sampling in the above steps can be upsampling or downsampling, depending on the spatial scale of the first difference feature e₀ⁿ and the spatial scale of the low-frequency feature jⁿ².

Step 4: Additively fusing the low-frequency feature jⁿ² and the second sampled feature q₀ⁿ(e₀ⁿ) to generate a fused feature J₀ⁿ corresponding to the first feature to be fused J₀.

The process of the above step 4 may be described as:

$${J}_{0}^{n} = {q}_{0}^{n} ( {e}_{0}^{n} ) + {j}^{n 2}$$

Step c: fusing other features to be fused in the first sorting result and the fused feature corresponding to the previous feature to be fused one by one, to obtain fused features corresponding to other features to be fused in the first sorting result.

In some embodiments, in step c above, the implementation of fusing the m-th (a positive integer greater than 1) feature to be fused in the first sorting result and the fused feature corresponding to the previous feature to be fused (the m−1 feature to be fused) includes the following steps I to VI:

Step I: Sampling the fused feature corresponding to the m−1-th feature to be fused in the first sorting result as a third sampled feature.

Wherein, the third sampled feature has the same spatial scale as the m-th feature to be fused in the first sorting result.

Step II: Calculating the difference between the m-th feature to be fused and the third sampled feature to obtain a second difference feature.

Step III: Sampling the second difference feature as a fourth sampled feature.

Wherein, the fourth sampled feature has the same spatial scale as the fused feature corresponding to the m−1-th feature to be fused.

Step VI: Additively fusing the fused feature corresponding to the m−1-th feature to be fused and the fourth sampled feature to generate a fused feature corresponding to the m-th feature to be fused.

The only difference between obtaining the fusion result of the m-th feature to be fused in the first sorting result in steps I to VI and obtaining the fusion result of the first feature to be fused in the first sorting result in steps 1 to 4 is that: when obtaining the fusion result of the first feature to be fused, the input is the third feature and the first feature to be fused, while when obtaining the fusion result of the m-th feature to be fused, the input is the fusion feature corresponding to the m−1 feature to be fused and the m-th feature to be fused, and the rest of the calculation methods are the same.

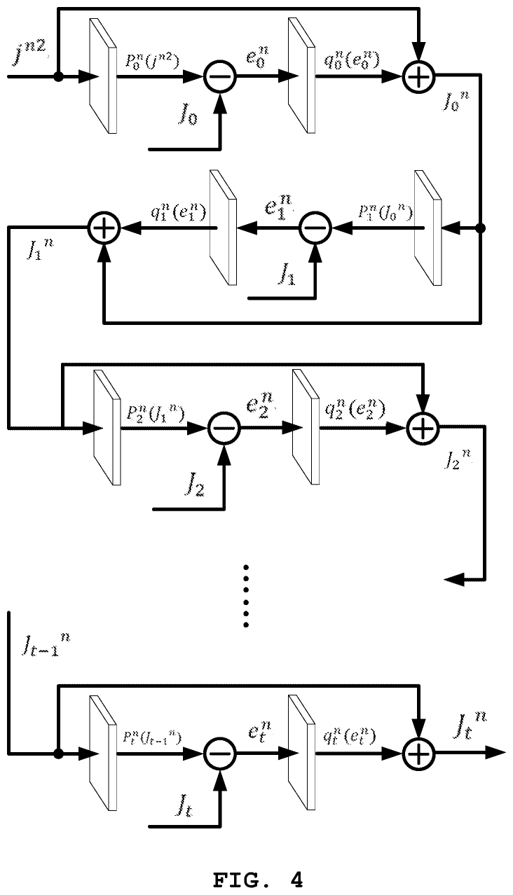

Exemplarily, with reference to FIG. 4, taking the first sorting result including in turn: the feature to be fused J₀, the feature to be fused J₁, the feature to be fused J₂, . . . , the feature to be fused Jₜ as an example to illustrate the above step C. On the basis of the embodiment shown in FIG. 3, after obtaining a fused feature J₀ⁿ corresponding to the first feature to be fused in the first sorting result, the process of obtaining fused features corresponding to other features to be fused in the first sorting result includes:

sampling the fusion result J₀ⁿ of the first feature to be fused J₀ in the first sorting result as a feature with the same spatial scale as the second feature to be fused J₁, to generate a first sampled feature P₁ⁿ (J₀ⁿ) corresponding to the second feature to be fused.
calculating the difference between the second feature to be fused J₁ and the first sampled feature P₀ⁿ(J₀ⁿ) corresponding to the second feature to be fused J₁, to obtain a difference feature e₁ⁿ corresponding to the second feature to be fused;
sampling the difference feature e₁ⁿ corresponding to the second feature to be fused J₁ as a feature with the same spatial scale as the fusion result J₀ⁿ of the first feature to be fused J₀, to obtain a second sampled feature q₁ⁿ(e₁ⁿ) corresponding to the second feature to be fused J₁;
additively fusing the fusion result J₀ⁿ of the first feature to be fused J₀ and the second sampled feature q₁ⁿ(e₁ⁿ) corresponding to the second feature to be fused J₁ to generate the fusion result J₁ⁿ of the second feature to be fused J₁;
sampling the fusion result J₁ⁿ of the second feature to be fused J₁ as a feature with the same spatial scale as the third feature to be fused J₂, to generate a first sampled feature P₂ⁿ(J₁ⁿ) corresponding to the third feature to be fused.
calculating the difference between the third feature to be fused J₂ and the first sampled feature P₂ⁿ(J₁ⁿ) corresponding to the third feature to be fused J₂, to obtain a difference feature e₂ⁿ corresponding to the third feature to be fused;
sampling the difference feature e₂ⁿ corresponding to the third feature to be fused J₂ as a feature with the same spatial scale as the fusion result J₁ⁿ of the second feature to be fused J₁, to obtain a second sampled feature q₂ⁿ(e₂ⁿ) corresponding to the third feature to be fused J₂;
additively fusing the fusion result J₁ⁿ of the second feature to be fused J₁ and a second sampled feature q₂ⁿ(e₂ⁿ) corresponding to the third feature to be fused J₂ to generate the fusion result J₂ⁿ of the third feature to be fused J₂;
   Based on the above method, fusion results Jₜⁿ of the 4-th feature to be fused J₃, the 5th feature to be fused J₄, . . . , the t-th feature to be fused Jₜ₋₁, and the t+1 feature to be fused Jₜ in the first sorting result are obtained one by one.

Step d: Determine the fused feature corresponding to the last feature to be fused in the first sorting result as the third feature.

Following the embodiment shown in FIG. 4, the first sorting result includes in turn: the feature to be fused J₀, the feature to be fused J₁, the feature to be fused J₂, . . . , the feature to be fused Jₜ, so the fusion result Jₜⁿ of the last feature to be fused Jₜ in the first sorting result is determined as the third feature.

That is, the embodiment of the present disclosure performs feature processing in two feature processing branches, one of which performs the feature processing step of step S12, and the other feature processing branch performs the feature processing steps of steps S13 to S15.

It should be noted that the order in which the feature processing steps are executed by the two feature processing branches is not limited in the embodiment of the present disclosure. Steps S13 to S15 may be executed first, and then step S12 is executed, or step S12 may be executed first, and then steps S13 to S15 are executed, or they are executed simultaneously.

S16. Combining the second feature, the third feature and the first feature to obtain a fused feature.

Specifically, combining the second feature, the third feature and the first feature may include: connecting the second feature, the third feature and the first feature in series in the channel dimension.

S17. Processing the image to be processed based on the fused feature.

The embodiment of the present disclosure provides an image processing method that can be used in any image processing scenario. For example, the image processing method provided by the embodiment of the present disclosure may be an image defogging method; for another example, the image processing method provided by the embodiment of the present disclosure may also be an image enhancement method. As another example: the image processing method provided by the embodiment of the present disclosure may also be an image super-resolution method.

The image processing methods provided by the embodiments of the present disclosure, after performing feature extraction on an image to be processed from a plurality of different spatial scales to obtain a target feature and at least one feature to be fused, on one hand, fuse the target feature and the at least one feature to be fused to obtain a first feature; on the other hand, extract high-frequency features and low-frequency features from the target feature, and perform the high-frequency features based on a residual dense block (RDB) to obtain a second feature, and fuse the low-frequency features and the at least one feature to be fused to obtain a third feature; finally, combine the first feature, the second feature and the third feature to obtain a fused feature, and process the image to be processed based on the fused feature. Since processing features based on RDBs can perform feature updating and redundant feature generation, and fusing low-frequency features and features to be fused can enable introduction of effective information from features at other spatial scales and achieve multi-scale feature fusion, the image processing methods provided by the embodiments of the present disclosure can ensure the generation of new high-frequency features when realizing multi-scale feature fusion of low-frequency features, and fusing of the target feature and the at least one feature to be fused can further enable introduction of effective information from features at other spatial scales, therefore, the image processing methods provided by the embodiments of the present disclosure can improve the effect of image processing.

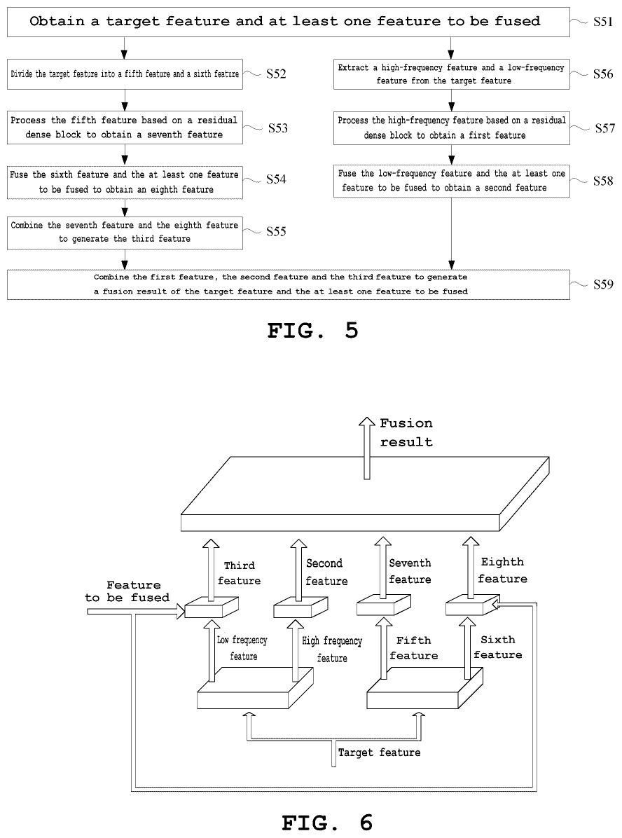

As an expansion and refinement to the above embodiments, an embodiment of the present disclosure provides another image processing method. With reference to a flow chart of steps of an image processing method shown in FIG. 5 and a structural diagram of a feature fusion network shown in FIG. 6, the image processing method includes the following steps:

S51. Performing feature extraction on an image to be processed from a plurality of different spatial scales respectively, to obtain a target feature and at least one feature to be fused.

S52. Dividing the target feature into a fifth feature and a sixth feature.

In some embodiments, the dividing the target feature into a fifth feature and a sixth feature includes:
dividing the target feature into a fifth feature and a sixth feature based on feature channels of the target feature.

The ratio of the fifth feature and the sixth feature is not limited in the embodiment of the present disclosure. The higher the proportion of the fifth feature, the more new features can be generated. The higher the proportion of the sixth feature, the more effective information of features of other spatial scales can be introduced. Therefore, in practical applications, the ratio of the fifth feature and the sixth feature can be determined according to the amount of effective information from features at other spatial scales that need to be introduced and the quantity of new features that need to be generated. Exemplarily, the ratio of the fifth feature and the sixth feature may be 1:1.

S53. Processing the fifth feature based on a residual dense block to obtain a seventh feature.

S54. Fusing the sixth feature and the at least one feature to be fused to obtain an eighth feature.

As an implementation of the embodiment of the present disclosure, the above step S54 (fusing the sixth feature and the at least one feature to be fused to obtain an eighth feature) includes:
sorting the at least one feature to be fused in descending order according to the spatial scale difference between the at least one feature to be fused and the sixth feature, to obtain a second sorting result;
fusing a second feature to be fused and the sixth feature to obtain the fused feature corresponding to the second feature to be fused, the second feature to be fused being the first feature to be fused in the second sorting result;
fusing other features to be fused in the second sorting result and the fused feature corresponding to the previous feature to be fused one by one, to obtain fused features corresponding to the other features to be fused in the second sorting result; and
determining the fused feature corresponding to the last feature to be fused in the second sorting result as the eighth feature.

Further, the fusing the second feature to be fused and the sixth feature to obtain the fused feature corresponding to the second feature to be fused includes:
sampling the sixth feature as a fifth sampled feature, the fifth sampled feature having the same spatial scale as the second feature to be fused;
calculating the difference between the fifth sampled feature and the first feature to be fused in the second sorting result, to obtain the third difference feature;
sampling the third difference feature as a sixth sampled feature, the sixth sampled feature having the same spatial scale as the sixth feature; and
additively fusing the sixth feature and the sixth sampled feature to generate a fused feature corresponding to the second feature to be fused.

Further, the fusing other features to be fused in the second sorting result and the fused features corresponding to the previous feature to be fused one by one, to obtain fused features corresponding to other features to be fused in the second sorting result includes:
sampling the fused feature corresponding to the n−1-th feature to be fused in the second sorting result as a seventh sampled feature; the seventh sampled feature having the same spatial scale as the n-th feature to be fused in the second sorting result, n being an integer greater than 1;
calculating the difference between the n-th feature to be fused and the seventh sampled feature to obtain a fourth difference feature;
sampling the fourth difference feature as an eighth sampled feature, the eighth sampled feature having the same spatial scale as the fused feature corresponding to the n−1-th feature to be fused; and
additively fusing the fused feature corresponding to the n−1-th feature to be fused and the eighth sampled feature to generate a fused feature corresponding to the n-th feature to be fused.

The implementation of fusing the sixth feature and the at least one feature to be fused to obtain an eighth feature is similar to the implementation of fusing the low-frequency feature and the at least one feature to be fused to obtain a third feature in the embodiment shown in FIG. 1. Therefore, the implementation of the step S54 in the above embodiment may refer to the implementation of the step S14 above, which will not be repeated here.

S55. Combining the seventh feature and the eighth feature to generate the first feature.

S56. Extracting high-frequency features and low-frequency features from the target feature.

S57. Processing the high-frequency features based on a residual dense block to obtain a second feature.

S58: Fusing the low-frequency feature and the at least one feature to be fused to obtain a third feature.

S59. Combining the first feature, the second feature and the third feature to obtain a fused feature.

It should be noted that in the above embodiment, taking the seventh feature and the eighth feature being combined first to generate the first feature, and then the second feature, the third feature and the first feature being combined to generate the target feature and the fused feature as an example, but in actual execution, the second feature, the third feature, the seventh feature and the eighth feature may also be synthesized and combined through the same step to generate the fused feature.

The image processing methods provided by the embodiments of the present disclosure, after performing feature extraction on an image to be processed from a plurality of different spatial scales to obtain a target feature and at least one feature to be fused, on one hand, fuse the target feature and the at least one feature to be fused to obtain a first feature; on the other hand, extract high-frequency features and low-frequency features from the target feature, and perform the high-frequency features based on a residual dense block (RDB) to obtain a second feature, and fuse the low-frequency features and the at least one feature to be fused to obtain a third feature; finally, combine the first feature, the second feature and the third feature to obtain a fused feature, and process the image to be processed based on the fused feature. Since processing features based on RDBs can perform feature updating and redundant feature generation, and fusing low-frequency features and features to be fused can enable introduction of effective information from features at other spatial scales and achieve multi-scale feature fusion, the image processing methods provided by the embodiments of the present disclosure can ensure the generation of new high-frequency features when realizing multi-scale feature fusion of low-frequency features, and fusing of the target feature and the at least one feature to be fused can further enable introduction of effective information from features at other spatial scales, therefore, the image processing methods provided by the embodiments of the present disclosure can improve the effect of image processing.

It should also be noted that when features from a plurality of spatial scales are fused, upsampling/downsampling convolution and deconvolution are generally required, and the upsampling/downsampling convolution and deconvolution require a large amount of computing resources, so the performance overhead is large. The above embodiment divides a target feature into a fifth feature and a sixth feature, and only makes the sixth feature participate in multi-spatial scale feature fusion. Therefore, the above embodiment can also reduce the number of features that need to be fused (the number of features of the sixth feature is less than the number of features of the target feature), thereby reducing the calculation amount of feature fusion and improving the efficiency of feature fusion.

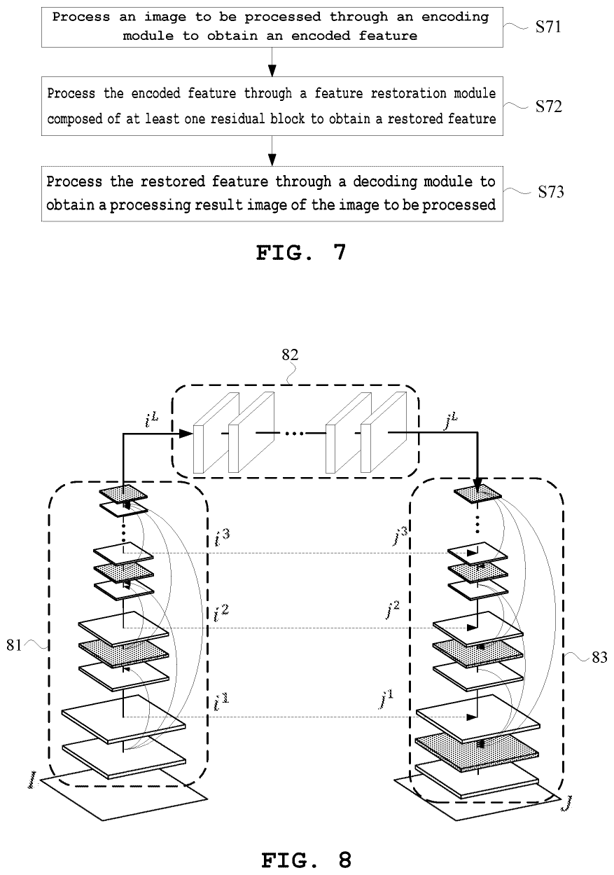

On the basis of the above embodiment, an embodiment of the present disclosure further provides an image processing method. With reference to FIG. 7, the image processing method provided by the embodiment of the present disclosure includes the following steps S71 to S73:

S71. Processing an image to be processed through an encoding module to obtain an encoded feature.

Wherein, the encoding module includes L cascaded encoders with different spatial scales, and the m-th encoder is used to perform feature extraction on the image to be processed to obtain an image feature on the i-th encoder, and obtain fused features output by all encoders before the i-th encoder, and obtain the fused feature of the i-th encoder through the image processing method described in any one of claims 1-11, and output the fused features of the i-th encoder to all encoders after the i-th encoder, L and i both being positive integers, and i≤L.

S72. Processing the encoded feature through a feature restoration module composed of at least one residual block (RDB) to obtain a restored feature.

S73: Processing the restored feature through a decoding module to obtain a processing result image of the image to be processed.

Wherein, the decoding module includes L cascaded decoders with different spatial scales, and the j-th decoder is used to fuse an image feature of the encoding module on the j-th encoder and the fusion results output by all decoders before the j-th decoder, generate a fusion result of the j-th decoder, and output the fusion result of the j-th decoder to all decoders after the j-th decoder.

That is, the encoding module, the feature restoration module and the decoding module used to execute the embodiment shown in FIG. 7 form a U-Net.

Specifically, the U-Net is a special convolutional neural network. The U-Net neural network mainly includes: an encoding module (also called contraction path), a feature restoration module and a decoding module (also called expansion path). The encoding module is mainly used to capture context information in the original image, while its corresponding decoding module is used to accurately localize the parts that need to be segmented in the original image, and then generate a processed image. Compared with a Fully Convolutional Neural Network (FCN), the improvement for the U-Net is that, in order to accurately locate the parts that need to be segmented in the original image, features extracted on the encoding module are combined with a new feature map in the upsampling process, to retain important information in the features to the greatest extent, thus reducing the demand for the number of training samples and computing resources.

As an implementation of the embodiment of the present disclosure, the processing the restored feature through a decoding module to obtain a processing result image of the image to be processed includes:
dividing the image feature on the j-th decoder into a ninth feature and a tenth feature;
processing the ninth feature based on a residual dense block (RDB) to obtain an eleventh feature;
fusing the tenth feature and fusion results output by all decoders before the j-th decoder to obtain a twelfth feature;
combining the eleventh feature and the twelfth feature to generate a fusion result of the j-th decoder.

Referring to FIG. 8, the network model used to execute the embodiment shown in FIG. 7 includes: an encoding module 81, a feature restoration module 82 and a decoding module 83 forming a U-Net.

The encoding module 81 includes L cascaded encoders with different spatial scales, which are used to process an image to be processed I to obtain an encoded feature i. Wherein, the j-th decoder is used to fuse image features of the encoding module on the j-th encoder and fusion results output by all decoders before the j-th decoder to generate the fusion result of the j-th decoder, and output the fusion result of the j-th decoder to all decoders after the j-th decoder.

The feature restoration module 82 includes at least one RDB, which is used to receive the encoded feature i^{L} output by the encoding module 81, and process the encoded feature i^{L} through the at least one RDB to obtain a restored feature j^{L}.

The decoding module 83 includes L cascaded decoders with different spatial scales. The j-th decoder is used to fuse image features of the encoding module on the j-th encoder and fusion results output by all decoders before the j-th decoder, generate a fusion result of the j-th decoder, and output the fusion result of the j-th decoder to all decoders after the j-th decoder; and obtain a processing result image J of the image to be processed I according to the fusion result j¹ output by the last decoder.

Operations of the m-th encoder in the encoding module 81 fusing image features of the encoding module on the m-th encoder and fusion results output from all encoders before the m-th encoder (the 1-st encoder to the m−1-th encoder) through the image processing method provided in the above embodiment may be described as:

$${i}^{m} = {i}^{m 1} + {i}^{m 2}$$

$${\tilde{ι}}^{m 1} = f ( {i}^{m 1} )$$

$${\tilde{ι}}^{m 2} = {D}_{en}^{m} ( {i}^{m 2} , \{ {\tilde{ι}}^{1} , {\tilde{ι}}^{2} , {\tilde{ι}}^{3} , … … {\tilde{ι}}^{m - 1} \} )$$

$${i}^{m} = {i}^{GF} + {i}^{LF}$$

$${\tilde{ι}}^{GF} = f ( {i}^{GF} )$$

$${\tilde{ι}}^{LF} = {D}_{en}^{m} ( {i}^{LF} , \{ {\tilde{ι}}^{1} , {\tilde{ι}}^{2} , {\tilde{ι}}^{3} , … … {\tilde{ι}}^{m - 1} \} )$$

$${\tilde{ι}}^{m} = {\tilde{ι}}^{GF} + {\tilde{ι}}^{LF} + {\tilde{ι}}^{m 1} + {\tilde{ι}}^{m 2}$$

Wherein, i^{m} represents a feature of the encoding module 81 on the m-th encoder, i^{GF} represents high-frequency features extracted from i^{m}, f( . . . ) represents an operation of processing the feature based on an RDB, i^{GF} represents features obtained by processing i^{GF} based on the RDB, i^{LF} represents low-frequency features extracted from i^{m}, {ĩ¹, ĩ², ĩ³, . . . ĩ^{m-1}} represents fusion results output from the 1-st encoder to the m−1-th encoder, Dₑₙ^{m} represents a feature fusion operation, ĩ^{LF} represents the fusion result obtained by fusing i^{LF} and {ĩ¹, ĩ², ĩ³, . . . ĩ^{m-1}}, i^{m1} represents a fifth feature obtained by dividing i^{m}, ĩ^{m1} represents a seventh feature obtained by processing i^{m1} based on the RDB, i^{m2} represents a sixth feature obtained by dividing i^{m}, ĩ^{m2} represents the fusion result obtained by fusing i^{m2} and {ĩ¹, ĩ², ĩ³, . . . ĩ^{m-1}}, and ĩ^{m} represents the fusion result output by the m-th encoder of the encoding module 81.

Operations of the m-th decoder in the decoding module 83 fusing image features of the decoding module on the m-th decoder and fusion results output from all decoders before the m-th decoder (the L-th decoder to the m+1-th decoder) through the image processing method provided in the above embodiment may be described as:

$${j}^{m} = {j}^{m 1} + {j}^{m 2}$$

$${\tilde{J}}^{m 1} = f ( {j}^{m 1} )$$

$${\tilde{J}}^{m 2} = {D}_{de}^{m} ( {j}^{m 2} , \{ {\tilde{J}}^{L} , {\tilde{J}}^{L - 1} , {\tilde{J}}^{L - 2} , … … {\tilde{J}}^{M + 1} \} )$$

$${\tilde{J}}^{m} = {\tilde{J}}^{m 1} + {\tilde{J}}^{m 2}$$

Wherein, j^{m} represents a feature of the decoding module 83 in the m-th decoder, j^{m1} represents a ninth feature obtained by dividing j^{m}, f( . . . ) represents an operation of processing the feature based on an RDB, \tilde{j}^{m1} represents an eleven feature obtained by processing j^{m1} based on the RDB, j^{m2} represents a tenth feature obtained by dividing j^{m}, L is the total number of the decoders in the decoding module 83, {\tilde{j}^{L}, \tilde{j}^{L-1}, \tilde{j}^{L-2}, . . . \tilde{j}^{m+1}} represents fusion results output by the L-th decoder to the m+1-th decoder, D_{de}^{m} represents an fusion operation on \tilde{j}^{m2} and {\tilde{j}^{L}, \tilde{j}^{L-1}, \tilde{j}^{L-2}, . . . \tilde{j}^{m+1}}, \tilde{j}^{m2} represents the fusion result obtained by fusing j^{m2} and {\tilde{j}^{L}, \tilde{j}^{L-1}, \tilde{j}^{L-2}, . . . \tilde{j}^{m+1}}, and \tilde{j}^{m} represents the fusion result output by the m-th decoder of the decoding module 83.

Since the image processing method provided by the embodiment of the present disclosure can perform feature fusion through the image processing method provided by the above embodiment, the image processing method provided by the embodiment of the present disclosure can ensure the generation of new high-frequency features when realizing multi-scale feature fusion of low-frequency features, therefore, the image processing method provided by the embodiment of the present disclosure can improve the effect of image processing.

Based on the same inventive concept, as an implementation of the above method, an embodiment of the present disclosure further provides an image processing apparatus, which corresponds to the foregoing method embodiment. For ease of reading, this apparatus embodiment will not repeat the details in the foregoing method embodiments one by one, but it should be clear that the image processing apparatus in this embodiment can correspondingly implement all the contents in the foregoing method embodiments.

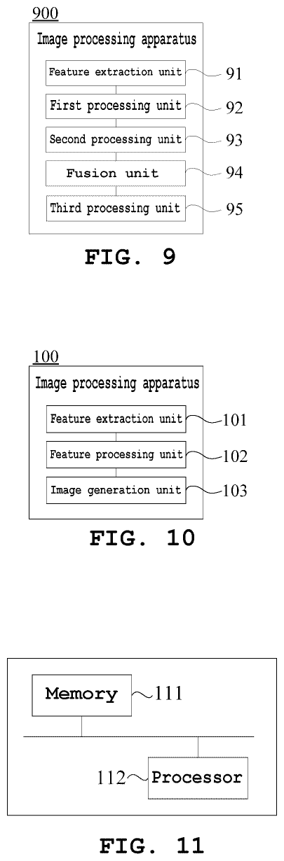

An embodiment of the present disclosure provides an image processing apparatus. FIG. 9 is a schematic structural diagram of the image processing apparatus. As shown in FIG. 9, the image processing apparatus 900 comprises:
a feature extraction unit 91 configured to perform feature extraction on an image to be processed from a plurality of different spatial scales respectively, to obtain a target feature and at least one feature to be fused;
a first processing unit 92 configured to fuse the target feature and the at least one feature to be fused to obtain a first feature;
a second processing unit 93 configured to extract high-frequency features and low-frequency features from the target feature, process the high-frequency features based on a residual dense block (RDB) to obtain a second features, and fuse the low-frequency features and the at least one feature to be fused to obtain a third feature;
a fusion unit 94 configured to combine the first feature, the second feature and the third feature to obtain a fused feature;
a third processing unit 95 configured to process the image to be processed based on the fused feature.

As an implementation of the embodiment of the present disclosure, the second processing unit 93 is specifically configured to perform discrete wavelet decomposition on the target feature to obtain a fourth feature;
determine features of first preset number of channels of the fourth feature as the low-frequency features, and features of other channels in the fourth feature except the low-frequency features as the high-frequency features.

As an implementation of the embodiment of the present disclosure, the second processing unit 93 is further configured to process the high-frequency features and the low-frequency features respectively through a convolution layer to reduce the number of channels of the high-frequency features and the low-frequency features to a preset value.

As an implementation of the embodiment of the present disclosure, the second processing unit 93 is specifically configured to sort the at least one feature to be fused in descending order according to the spatial scale difference between the at least one feature to be fused and the low-frequency features, to obtain a first sorting result; fuse the first feature to be fused and the low-frequency feature to obtain the fused feature corresponding to the first feature to be fused, the first feature to be fused being the first feature to be fused in the first sorting result; fuse other features to be fused in the first sorting result and the fused feature corresponding to the previous feature to be fused one by one, to obtain fused features corresponding to other features to be fused in the first sorting result; and determine the corresponding fused feature of the last feature to be fused in the first sorting result as the third feature.

As an implementation of the embodiment of the present disclosure, the second processing unit 93 is specifically configured to sample the low-frequency feature as a first sampled feature; the first sampled feature having the same spatial scale as the first feature to be fused; calculate the difference between the first sampled feature and the first feature to be fused, to obtain a first difference feature; sample the first difference feature as a second sampled feature; the second sampled feature having the same spatial scale as the low-frequency feature; and additively fusing the low-frequency feature and the second sampled feature to generate a fused feature corresponding to the first feature to be fused.

As an implementation of the embodiment of the present disclosure, the second processing unit 93 is specifically configured to sample the fused feature corresponding to the m−1-th feature to be fused in the first sorting result as a third sampled feature; the third sampled feature having the same spatial scale as the m-th feature to be fused in the first sorting result, m being an integer greater than 1; calculate the difference between the m-th feature to be fused and the third sampled feature to obtain a second difference feature; sample the second difference feature as a fourth sampled feature; the fourth sampled feature having the same spatial scale as the fused feature corresponding to the m−1-th feature to be fused; and additively fuse the fused feature corresponding to the m−1-th feature to be fused and the fourth sampled feature to generate a fused feature corresponding to the m-th feature to be fused.

As an implementation of the embodiment of the present disclosure, the first processing unit 92 is specifically configured to divide the target feature into a fifth feature and a sixth feature; process the fifth feature based on a residual dense block (RDB) to obtain a seventh feature; fuse the sixth feature and the at least one feature to be fused to obtain an eighth feature; combine the seventh feature and the eighth feature to generate the first feature.

As an implementation of the embodiment of the present disclosure, the first processing unit 92 is specifically configured to sort the at least one feature to be fused in descending order according to the spatial scale difference between the at least one feature to be fused and the sixth feature, to obtain a second sorting result; fuse a second feature to be fused and the sixth feature to obtain the fused feature corresponding to the second feature to be fused, the second feature to be fused being the first feature to be fused in the second sorting result; fuse other features to be fused in the second sorting result and the fused feature corresponding to the previous feature to be fused one by one, to obtain fused features corresponding to the other features to be fused in the second sorting result; and determine the fused feature corresponding to the last feature to be fused in the second sorting result as the eighth feature.

As an implementation of the embodiment of the present disclosure, the first processing unit 92 is specifically configured to sample the sixth feature as a fifth sampled feature, the fifth sampled feature having the same spatial scale as the second feature to be fused; calculate the difference between the fifth sampled feature and the first feature to be fused in the second sorting result, to obtain the third difference feature; sample the third difference feature as a sixth sampled feature, the sixth sampled feature having the same spatial scale as the sixth feature; and additively fuse the sixth feature and the sixth sampled feature to generate a fused feature corresponding to the second feature to be fused.

As an implementation of the embodiment of the present disclosure, the first processing unit 92 is specifically configured to sample the fused feature corresponding to the n−1-th feature to be fused in the second sorting result as a seventh sampled feature; the seventh sampled feature having the same spatial scale as the n-th feature to be fused in the second sorting result, n being an integer greater than 1; calculate the difference between the n-th feature to be fused and the seventh sampled feature to obtain a fourth difference feature; sample the fourth difference feature as an eighth sampled feature, the eighth sampled feature having the same spatial scale as the fused feature corresponding to the n−1-th feature to be fused; and additively fuse the fused feature corresponding to the n−1-th feature to be fused and the eighth sampled feature to generate a fused feature corresponding to the n-th feature to be fused.

As an implementation of the embodiment of the present disclosure, the first processing unit 92 is specifically configured to divide the target feature into a fifth feature and a sixth feature based on feature channels of the target feature.

The image processing apparatus provided in this embodiment can execute the image processing method provided in the above method embodiment. Their implementation principles and technical effects are similar, which will not be repeated here.

Based on the same inventive concept, as an implementation of the above method, an embodiment of the present disclosure further provides an image processing apparatus, which corresponds to the foregoing method embodiment. For ease of reading, this apparatus embodiment will not repeat the details in the foregoing method embodiments one by one, but it should be clear that the image processing apparatus in this embodiment can correspondingly implement all the contents in the foregoing method embodiments.

An embodiment of the present disclosure provides an image processing apparatus. FIG. 10 is a schematic structural diagram of the image processing apparatus. As shown in FIG. 10, the image processing apparatus 100 comprises:

a feature extraction unit 101 configured to process an image to be processed through an encoding module to obtain an encoded feature; wherein the encoding module includes L cascaded encoders with different spatial scales, and the i-th encoder is used to perform feature extraction on the image to be processed to obtain an image feature on the i-th encoder, and obtain fused features output by all encoders before the i-th encoder, and obtain the fused feature of the i-th encoder through the image processing method described in any one of claims 1-11, and output the fused features of the i-th encoder to all encoders after the i-th encoder, L and i both being positive integers, and i≤L;
a feature processing unit 102 configured to process the encoded feature through a feature restoration module composed of at least one residual block (RDB) to obtain a restored feature;
an image generation unit 103 is configured to process the restored feature through a decoding module to obtain a processing result image of the image to be processed; wherein the decoding module includes L cascaded decoders with different spatial scales, and the j-th decoder is used to fuse an image feature of the encoding module on the j-th encoder and the fusion results output by all decoders before the j-th decoder, generate a fusion result of the j-th decoder, and output the fusion result of the j-th decoder to all decoders after the j-th decoder.

As an implementation of the embodiment of the present disclosure, the image generation unit 103 is specifically configured to divide the image feature on the j-th decoder into a ninth feature and a tenth feature; process the ninth feature based on a residual dense block (RDB) to obtain an eleventh feature; fuse the tenth feature and fusion results output by all decoders before the j-th decoder to obtain a twelfth feature; combine the eleventh feature and the twelfth feature to generate a fusion result of the j-th decoder.

The image processing apparatus provided in this embodiment can execute the image processing method provided in the above method embodiment. Their implementation principles and technical effects are similar, which will not be repeated here.

Based on the same inventive concept, an embodiment of the present disclosure further provides an electronic device. FIG. 11 is a schematic structural diagram of an electronic device provided by an embodiment of the present disclosure. As shown in FIG. 11, the electronic device provided by the embodiment comprises: a memory 111 and a processor 112, wherein the memory 111 is configured to store a computer program; the processor 112 is configured to, when calling the computer program, execute the image processing method provided by the above embodiments.

Based on the same inventive concept, an embodiment of the present disclosure further provides a computer-readable storage medium having a computer program stored thereon, which, when executed by a processor, causes the computing device to implement the image processing method provided by the above embodiments.

Based on the same inventive concept, an embodiment of the present disclosure further provides a computer program product, which, when runs on a computer, causes the computing device to implement the image processing method provided in the above embodiments.

Those skilled in the art will appreciate that embodiments of the present disclosure may be provided as methods, systems, or computer program products. Thus, the present disclosure may take the form of an entirely hardware embodiment, an entirely software embodiment, or an embodiment combining software and hardware aspects. Furthermore, the present disclosure may take the form of a computer program product embodied on one or more computer-usable storage media having computer-usable program code contained therein.

The processor may be a Central Processing Unit (CPU), other general-purpose processor, a Digital Signal Processor (DSP), an Application Specific Integrated Circuit (ASIC), or a Field-Programmable Gate Array (FPGA) or other programmable logic device, a discrete gate or transistor logic device, a discrete hardware component, etc. A general-purpose processor may be a microprocessor or the processor may be any conventional processor, etc.

The memory may include the form of a non-persistent memory, a random access memory (RAM) and/or a non-volatile memory, etc. in computer-readable media, for example, a read-only memory (ROM) or a flash RAM. The memory is an example of computer-readable media.

The computer-readable media include persistent and non-persistent, removable and non-removable storage media. The storage media may be implemented by any method or technology to store information, and the information may be computer-readable instructions, data structures, program modules, or other data. Examples of computer storage media include, but are not limited to, a phase change memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technology, a compact disc read-only memory (CD-ROM), a digital versatile disc (DVD) or other optical storage, a magnetic tape cassette, a magnetic disk storage or other magnetic storage devices or any other non-transmission medium, which can be used to store information that can be accessed by a computing device. The computer-readable media, as defined herein, exclude transitory media, such as modulated data signals and carrier waves.

Finally, it should be noted that the above embodiments are only used to illustrate the technical solutions of the present disclosure, but not to limit them; although the present disclosure has been described in detail with reference to the foregoing embodiments, those of ordinary skill in the art should understand that: the technical solutions recited in the foregoing embodiments can still be modified, or some or all of the technical features thereof can be equivalently substituted; and these modifications or substitutions do not make the essence of the corresponding technical solutions deviate from the range of the technical solutions of the embodiments of the present disclosure.

1. An image processing method, comprising:
performing feature extraction on an image to be processed from a plurality of different spatial scales respectively, to obtain a target feature and at least one feature to be fused;
fusing the target feature and the at least one feature to be fused to obtain a first feature;
extracting high-frequency features and low-frequency features from the target feature;
processing the high-frequency features based on a residual dense block (RDB) to obtain a second feature;
fusing the low-frequency features and the at least one feature to be fused to obtain a third feature;
combining the first feature, the second feature and the third feature to obtain a fused feature; and
processing the image to be processed based on the fused feature.

2. The method according to claim 1, the extracting high-frequency features and low-frequency features from the target feature includes:
performing discrete wavelet decomposition on the target feature to obtain a fourth feature;
determining features of first preset number of channels of the fourth feature as the low-frequency features, and features of other channels in the fourth feature except the low-frequency features as the high-frequency features.

3. The method according to claim 2, after extracting high-frequency features and low-frequency features in the target feature, the method further includes:
processing the high-frequency features and the low-frequency features respectively through a convolution layer to reduce the number of channels of the high-frequency features and the low-frequency features to a preset value.

4. The method according to claim 1, the fusing the low-frequency features and the at least one feature to be fused to obtain a third feature includes:
sorting the at least one feature to be fused in descending order according to the spatial scale difference between the at least one feature to be fused and the low-frequency features, to obtain a first sorting result;
fusing the first feature to be fused and the low-frequency feature to obtain the fused feature corresponding to the first feature to be fused, the first feature to be fused being the first feature to be fused in the first sorting result;
fusing other features to be fused in the first sorting result and the fused feature corresponding to the previous feature to be fused one by one, to obtain fused features corresponding to other features to be fused in the first sorting result; and
determining the corresponding fused feature of the last feature to be fused in the first sorting result as the third feature.

5. The method according to claim 4, the fusing the first feature to be fused and the low-frequency feature to obtain the fused feature corresponding to the first feature to be fused includes:
sampling the low-frequency feature as a first sampled feature; the first sampled feature having the same spatial scale as the first feature to be fused;
calculating the difference between the first sampled feature and the first feature to be fused, to obtain a first difference feature;
sampling the first difference feature as a second sampled feature; the second sampled feature having the same spatial scale as the low-frequency feature; and
additively fusing the low-frequency feature and the second sampled feature to generate a fused feature corresponding to the first feature to be fused.

6. The method according to claim 4, the fusing other features to be fused in the first sorting result and the fused feature corresponding to the previous feature to be fused one by one, to obtain fused features corresponding to other features to be fused in the first sorting result includes:
sampling the fused feature corresponding to the m−1-th feature to be fused in the first sorting result as a third sampled feature; the third sampled feature having the same spatial scale as the m-th feature to be fused in the first sorting result, m being an integer greater than 1;
calculating the difference between the m-th feature to be fused and the third sampled feature to obtain a second difference feature;
sampling the second difference feature as a fourth sampled feature; the fourth sampled feature having the same spatial scale as the fused feature corresponding to the m−1-th feature to be fused; and
additively fusing the fused feature corresponding to the m−1-th feature to be fused and the fourth sampled feature to generate a fused feature corresponding to the m-th feature to be fused.

7. The method according to claim 1, the fusing the target feature and the at least one feature to be fused to obtain a first feature includes:
dividing the target feature into a fifth feature and a sixth feature;
processing the fifth feature based on a residual dense block (RDB) to obtain a seventh feature;
fusing the sixth feature and the at least one feature to be fused to obtain an eighth feature;
combining the seventh feature and the eighth feature to generate the first feature.

8. The method according to claim 7, fusing the sixth feature and the at least one feature to be fused to obtain an eighth feature includes:
sorting the at least one feature to be fused in descending order according to the spatial scale difference between the at least one feature to be fused and the sixth feature, to obtain a second sorting result;
fusing a second feature to be fused and the sixth feature to obtain the fused feature corresponding to the second feature to be fused, the second feature to be fused being the first feature to be fused in the second sorting result;
fusing other features to be fused in the second sorting result and the fused feature corresponding to the previous feature to be fused one by one, to obtain fused features corresponding to the other features to be fused in the second sorting result; and
determining the fused feature corresponding to the last feature to be fused in the second sorting result as the eighth feature.

9. The method according to claim 8, the fusing a second feature to be fused and the sixth feature to obtain the fused feature corresponding to the second feature to be fused includes:
sampling the sixth feature as a fifth sampled feature, the fifth sampled feature having the same spatial scale as the second feature to be fused;
calculating the difference between the fifth sampled feature and the first feature to be fused in the second sorting result, to obtain the third difference feature;
sampling the third difference feature as a sixth sampled feature, the sixth sampled feature having the same spatial scale as the sixth feature; and
additively fusing the sixth feature and the sixth sampled feature to generate a fused feature corresponding to the second feature to be fused.

10. The method according to claim 8, the fusing other features to be fused in the second sorting result and the fused feature corresponding to the previous feature to be fused one by one, to obtain fused features corresponding to other features to be fused in the second sorting result includes:
sampling the fused feature corresponding to the n−1-th feature to be fused in the second sorting result as a seventh sampled feature; the seventh sampled feature having the same spatial scale as the n-th feature to be fused in the second sorting result, n being an integer greater than 1;
calculating the difference between the n-th feature to be fused and the seventh sampled feature to obtain a fourth difference feature;
sampling the fourth difference feature as an eighth sampled feature, the eighth sampled feature having the same spatial scale as the fused feature corresponding to the n−1-th feature to be fused; and
additively fusing the fused feature corresponding to the n−1-th feature to be fused and the eighth sampled feature to generate a fused feature corresponding to the n-th feature to be fused.

11. The method according to claim 7, the dividing the target feature into a fifth feature and a sixth feature includes:
dividing the target feature into a fifth feature and a sixth feature based on feature channels of the target feature.

12. The method according to claim 1, comprising:
processing an image to be processed through an encoding module to obtain an encoded feature; wherein the encoding module includes L cascaded encoders with different spatial scales, and the i-th encoder is used to perform feature extraction on the image to be processed to obtain an image feature on the i-th encoder, and obtain fused features output by all encoders before the i-th encoder, and obtain the fused feature of the i-th encoder, and output the fused features of the i-th encoder to all encoders after the i-th encoder, L and i both being positive integers, and i≤L;
processing the encoded feature through a feature restoration module composed of at least one residual block (RDB) to obtain a restored feature;
processing the restored feature through a decoding module to obtain a processing result image of the image to be processed; wherein the decoding module includes L cascaded decoders with different spatial scales, and the j-th decoder is used to fuse an image feature of the encoding module on the j-th encoder and the fusion results output by all decoders before the j-th decoder, generate a fusion result of the j-th decoder, and output the fusion result of the j-th decoder to all decoders after the j-th decoder.

13. The method according to claim 12, the processing the restored feature through a decoding module to obtain a processing result image of the image to be processed includes:
dividing the image feature on the j-th decoder into a ninth feature and a tenth feature;
processing the ninth feature based on a residual dense block (RDB) to obtain an eleventh feature;
fusing the tenth feature and fusion results output by all decoders before the j-th decoder to obtain a twelfth feature;
combining the eleventh feature and the twelfth feature to generate a fusion result of the j-th decoder.

14-15. (canceled)

16. An electronic device, comprising: a memory and a processor, wherein the memory is configured to store a computer program; the processor is configured to, when calling the computer program, cause the electronic device to implement an image processing method, comprising:
performing feature extraction on an image to be processed from a plurality of different spatial scales respectively, to obtain a target feature and at least one feature to be fused;
fusing the target feature and the at least one feature to be fused to obtain a first feature;
extracting high-frequency features and low-frequency features from the target feature;
processing the high-frequency features based on a residual dense block (RDB) to obtain a second feature;
fusing the low-frequency features and the at least one feature to be fused to obtain a third feature;
combining the first feature, the second feature and the third feature to obtain a fused feature; and
processing the image to be processed based on the fused feature.

17-18. (canceled)

19. The device according to claim 16, wherein the extracting high-frequency features and low-frequency features from the target feature includes:
performing discrete wavelet decomposition on the target feature to obtain a fourth feature;
determining features of first preset number of channels of the fourth feature as the low-frequency features, and features of other channels in the fourth feature except the low-frequency features as the high-frequency features.

20. The device according to claim 19, wherein after extracting high-frequency features and low-frequency features in the target feature, the method further includes:
processing the high-frequency features and the low-frequency features respectively through a convolution layer to reduce the number of channels of the high-frequency features and the low-frequency features to a preset value.

21. The device according to claim 16, wherein the fusing the low-frequency features and the at least one feature to be fused to obtain a third feature includes:
sorting the at least one feature to be fused in descending order according to the spatial scale difference between the at least one feature to be fused and the low-frequency features, to obtain a first sorting result;
fusing the first feature to be fused and the low-frequency feature to obtain the fused feature corresponding to the first feature to be fused, the first feature to be fused being the first feature to be fused in the first sorting result;
fusing other features to be fused in the first sorting result and the fused feature corresponding to the previous feature to be fused one by one, to obtain fused features corresponding to other features to be fused in the first sorting result; and
determining the corresponding fused feature of the last feature to be fused in the first sorting result as the third feature.

22. The device according to claim 21, wherein the fusing the first feature to be fused and the low-frequency feature to obtain the fused feature corresponding to the first feature to be fused includes:
sampling the low-frequency feature as a first sampled feature; the first sampled feature having the same spatial scale as the first feature to be fused;
calculating the difference between the first sampled feature and the first feature to be fused, to obtain a first difference feature;
sampling the first difference feature as a second sampled feature; the second sampled feature having the same spatial scale as the low-frequency feature; and
additively fusing the low-frequency feature and the second sampled feature to generate a fused feature corresponding to the first feature to be fused.

23. A non-transitory computer-readable storage medium having a computer program stored thereon, which, when executed by a computing device, causes the computing device to implement an image processing method, the image processing method comprises:
performing feature extraction on an image to be processed from a plurality of different spatial scales respectively, to obtain a target feature and at least one feature to be fused;
fusing the target feature and the at least one feature to be fused to obtain a first feature;
extracting high-frequency features and low-frequency features from the target feature;
processing the high-frequency features based on a residual dense block (RDB) to obtain a second feature;
fusing the low-frequency features and the at least one feature to be fused to obtain a third feature;
combining the first feature, the second feature and the third feature to obtain a fused feature; and
processing the image to be processed based on the fused feature.

24. The medium according to claim 23, wherein the extracting high-frequency features and low-frequency features from the target feature includes:
performing discrete wavelet decomposition on the target feature to obtain a fourth feature;
determining features of first preset number of channels of the fourth feature as the low-frequency features, and features of other channels in the fourth feature except the low-frequency features as the high-frequency features.
